(19) United States
(12) Patent Application Publication
(10) Pub. No.: US 2008/0115150 A1
(43) Pub. Date: May 15, 2008

(54) METHODS FOR APPLICATIONS TO UTILIZE CROSS OPERATING SYSTEM FEATURES UNDER VIRTUALIZED SYSTEM ENVIRONMENTS

(75) Inventors: Venkata R. Jagana, Portland, OR (US); John Ernest McGinn, Rochester, MN (US); Jerry Wayne Stevens, Raleigh, NC (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/560,087

(22) Filed: Nov. 15, 2006

(51) Int. Cl. G06F 9/44; G06F 13/00

(52) U.S. Cl. 719/319; 719/328

(57) ABSTRACT

Systems and methods for applications to utilize cross operating system features. Exemplary embodiments include a method for applications to utilize cross operating system features under system environments, the method including providing a communication stack in a provider system, generating protocol stack calls from an application in a consumer system, intercepting the protocol stack calls through a protocol stack interceptor-consumer residing on the consumer system, handing the intercepted protocol stack calls to a protocol stack interceptor-provider on the provider system and processing the protocol calls in the communication stack on the provider system for availability over a network to clients.

### TRADEMARKS

IBM® is a registered trademark of International Business Machines Corporation, Armonk, N.Y. U.S.A. Other names used herein may be registered trademarks, trademarks or product names of International Business Machines Corporation or other names.

### BACKGROUND OF THE INVENTION

1. Field of the Invention

This invention relates to methods for applications to utilize cross operating systems features.

2. Description of Background

Symmetric Multiprocessing (SMP) systems typically offer logical partioning capabilities, which allow multiple instances of the same or mixed operating systems to run on the same hardware. However, each operating system running on a given logical partition is unique in may respects including the core kernel and the feature capabilities that each of these operating systems offers. Some of the applications running on one of these operating system instances may not be available on other operating system instances.

One short-coming encountered with SMP systems can occur in a situation where some applications running on operating system A (OS-A) in partition A want to utilize some of advanced features available in operating system B (OS-B) running in partition B, since those features are not available in OS-A. Currently, there is no such mechanism available in such an environment for applications in OS-A to utilize the features in OS-B and to communicate with its peer applications using the same advanced features available on the remote end.

This problem is also applicable to a stand-alone system A running OS-A with applications wanting to utilize the advanced features not available in OS-A, but are available in another system B sunning OS-B. Further, these same types of problems also may be encountered in applications other than network based applications and advanced networking features. For example, these problems may apply to other ears of the operating system such as security, storage, systems management, and the like.

Accordingly, there is a need for methods for applications to utilize cross operating system features.

### SUMMARY OF THE INVENTION

Exemplary embodiments include a method for applications to utilize cross operating system features under system environments, the method including providing a communication stack in a provider system, generating protocol stack calls from an application in a consumer system, intercepting the protocol stack calls through a protocol stack interceptor-consumer residing on the consumer system, handing the intercepted protocol stack calls to a protocol stack interceptor-provider on the provider system and processing the protocol calls in the communication stack on the provider system for availability over a network to clients.

Additional embodiments include a system for applications to utilize cross operating system features under system environments, the system including a first application, a protocol stack interceptor-consumer coupled to the first application, a first transport medium coupled to the protocol stack interceptor-consumer, hardware coupled to the first transport medium, a protocol stack interceptor-provider for receiving protocol stack calls from the first application, a second transport medium coupled to the protocol stack interceptor-provider and a communication stack including a transport service layer and an transport medium driver, the communication stack coupled to the socket interceptor-provider, wherein the communication stack processes and transfers application operations to a client application on a network via the protocol stack calls that are handed from the protocol stack interceptor-consumer to the protocol stack interceptor-provider, via transport medium support mechanisms.

Further embodiments include an article of manufacture, including a set of application program interfaces embodied on a computer readable medium for execution on at least one of a partitioned system and a network system in conjunction with an application program that generates protocol stack calls, including socket calls, a protocol stack interceptor-consumer interface that receives the protocol stack calls from the application program, a protocol stack interceptor-provider interface that received the protocol stack calls that are handed from the protocol stack interceptor-provider interface and a communications stack interface having a transport service layer coupled to a transport medium driver layers, the communications stack interface receiving the protocol stack calls from the protocol stack interceptor-provider and providing the protocol stack calls to a network, wherein the protocol stack calls are handed from the protocol stack interceptor-consumer to the protocol stack interceptor-provider via at least one of an interpartition communication mechanism in the partitioned system and an intersystem communication mechanism in the networked system.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically a solution has been achieved which allows applications to utilize cross operating system features under a virtualized system environment.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment for exploitation of stream control transmission protocol (SCTP) in a partitioned system; and

FIG. 2 illustrates an exemplary embodiment for exploitation of SCTP through standalone systems.

The detailed description explains the preferred embodiments of the invention, together with advantages and features, by way of example with reference to the drawings.

### DETAILED DESCRIPTION OF THE INVENTION

Disclosed herein are methods are methods for applications to utilize cross operating system features under virtualized system environments. The method comprises intercepting socket calls to a first application using a socket interceptor, and transporting the intercepted calls to a second application using an interpartition communication mechanism in a partitioned system or an intersystem communication mechanism in a networked system environment. It is appreciated that the systems and methods described herein apply not only to the socket layer as described but also to other layers of the protocol stack.

In general, exemplary system described herein can be connected via Ethernet hardware/fabric, in which the underlying hardware fabric can be transparent for both systems that are in virtualized partitions or actual disparate systems. In accordance with exemplary embodiments, an environment in which the systems and methods can be implemented are clustered systems exploiting the underlying high speed computing/clustering fabric/technology and high performance computing (HPC) of the clustered systems, whereby within the cluster of systems/applications and the services provided by the communication sacks can be in separate systems (transparent to the actual applications).

In one embodiment, a separate stack interceptor is utilized depending on the level of feature to be used at each of the network stack layers and then the function call/data is transported to a different operating system instance supporting that feature through an interpartition communication mechanism in a partitioned system or through an intersystem communication mechanism in a networked system environment. For example, a networked client application (app-A) running on operating system A1 (OS-A1) in Partition A1 of system A needs to communicate with a server app (app-B) running on remote system B using a transport service such as a stream control transmission protocol (SCTP), wherein app-B supports services over SCTP. However, OS-A1 does not have the necessary support for SCTP transport protocol. As such, app-A is unable to communicate with app-B. However, Operating System A2 (OS-A2) in partition A2 of the same System A has the support for SCTP. In order to utilize the SCTP support available in OS-A2, a separate socket level interceptor (SI-A1-consumer) is used to intercept socket calls in OS-A1 utilizing SCTP transport and then transport this call to the OS-A2 through an interpartition communication mechanism utilizing a virtual Ethernet driver, for example. This intercepted call is handed to the socket interceptor (SI-A2-provider) in OS-A2. The SI-A2-provider directly interfaces with the SCTP running in OS-A2. Similarly, the reverse flow of these calls is handled through SI-A2 provider to SI-A1-consumer and then finally to app-A. It is understood that in other exemplary embodiments, other interpartition communication mechanisms such as Infiniband (i.e., a high performance, switched fabric interconnect standard for servers), or remote direct memory access (RDMA) over Ethernet can be implemented.

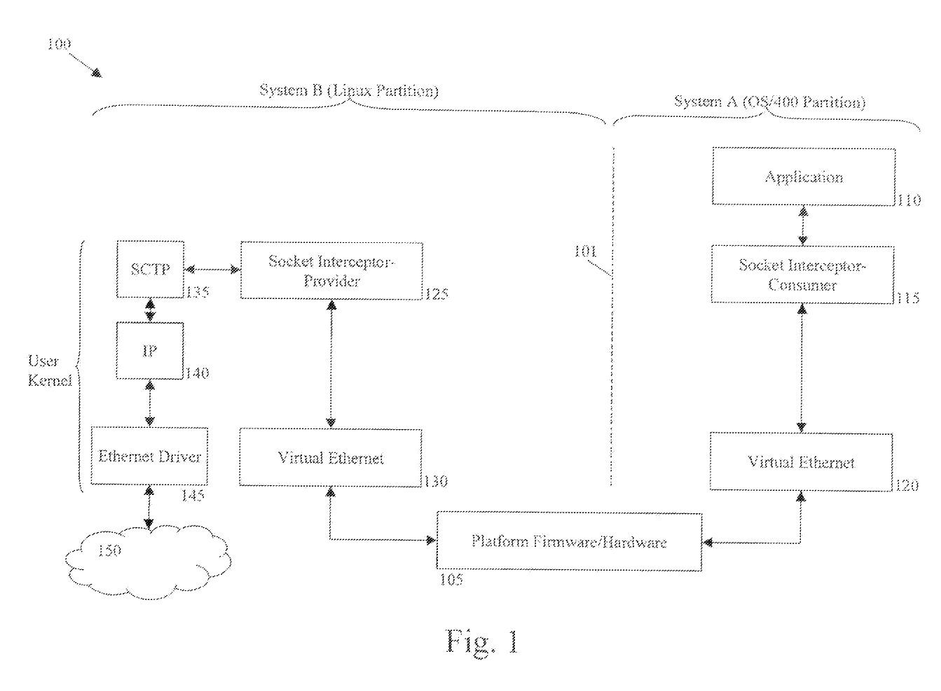

Turning now to the drawings in greater detail, FIG. 1 illustrates one example for exploitation of stream control transmission protocol (SCTP) in a partitioned system, including System A running on an OS/400 partition, and System B running on a Linux partition. System A and system B are separated by partition logical boundary 101. As illustrated, an application 110 is running in an OS/400 partition, System A. Application 110 is coupled to a socket interceptor-consumer 115, which is in turn coupled to virtual Ethernet 120 coupled to the platform firmware/hardware 105. Similarly, System B includes socket interceptor-provider 125 coupled to virtual Ethernet 130, which is coupled to the platform firmware/hardware 105. System B includes a user kernel supporting protocol layers, which includes SCTP layer 125 coupled to Internet Protocol (IP) layer 140, which is coupled to Ethernet driver 145. Ethernet driver 145 is ultimately coupled to a network 150. Therefore, it is appreciated that the SCTP function is available in Linux on the System B partition. During operation, socket interceptor-consumer 115 intercepts the socket calls from the application 110. The intercepted socket calls are handed to the socket interceptor-provider on the System B partition. Socket interceptor-provider is coupled and directly interfaced with the SCTP layer 125 and therefore runs. them remotely on Linux System B partition by executing as a remote procedure call (RPC) using Virtual Ethernet support mechanism to transport the data across partitions. As such, the clients on the network 150 are able to communicate with the application 110 (on OS/400) running over SCTP through the Linux partition.

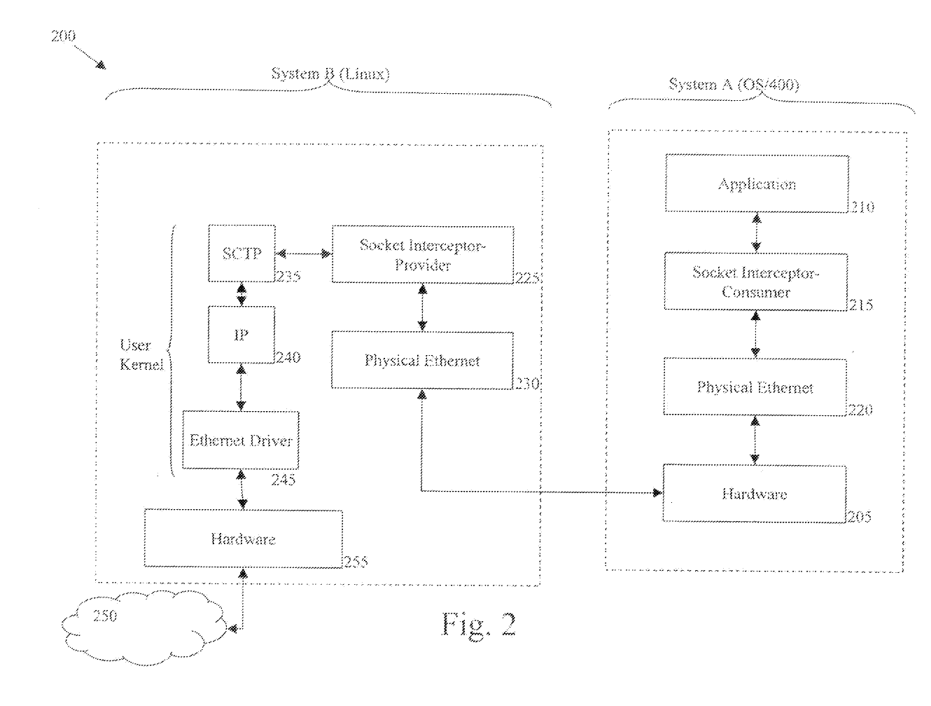

FIG. 2 illustrates an architecture model for exploitation of SCTP in standalone system environment through physical Ethernet support using socket interceptors. System 200 includes System A sunning on OS/400, and System B running Linux. System A and system B are separate standalone physical systems in contrast to the partitioned system 100 described above. As illustrated, an application 210 is running in OS/400 on System A. Application 210 is coupled to a socket interceptor-consumer 215, which is in turn coupled to physical Ethernet 220 (or other suitable high-speed/low latency communication mechanism) coupled to the system hardware 205. Similarly, System B includes socket interceptor-provider 225 coupled to physical Ethernet 230. As illustrated physical Ethernet 230 of system B can be coupled to system hardware 205 of System A, thereby coupling the physical systems to one another. System B includes a user kernel supporting protocol layers, which include SCTP layer 235 coupled to IP layer 240, which is coupled to Ethernet driver 245 (or any other IP supported transport media or hardware adapter driver). Ethernet drier 245 is coupled to the system hardware 255, which can ultimately be coupled to a network 250. Therefore, it is appreciated that the SCTP function is available in Linux on the System B to the application 210 on System A, but this time by physical system connection. During operation, socket interceptor-consumer 215 intercept the socket calls from the application 210. The intercepted socket calls are handed to the socket interceptor-provider on System B. Socket interceptor-provider 225 is coupled and directly interfaced with the SCTP layer 225 and therefore runs them remotely on the Linux System B by executing physical Ethernet support mechanisms to transport the data across systems. As such, the clients on the network 250 are able to communicate with the application 210 (on OS/400) running over SCTP through the Linux system.

Additionally, this similar architecture framework can further be extended to support the other transport protocols with minimal set of extensions to socket interceptors. Similarly, internet protocol (IP) related support over media such as IP over IB can be supported using a simple routing mechanism rather than through an intercept at the IP layer.

It is appreciated that the communication stack may have support for SCTP or other transport protocols such as datagram congestion control protocol (DCCP), and IP layer.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instruction executable by the machine to perform the capabilities of the present invention can be provided.

The flow diagrams depicted herein are just examples. There may be many variations to these diagrams of the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for applications to utilize cross operating system features under system environments, the method comprising:
providing a communication stack in a provider system;
generating protocol stack calls from an application in a consumer system;
intercepting the protocol stack calls through a protocol stack interceptor-consumer residing on the consumer system;
handing the intercepted protocol stack calls to a protocol stack interceptor-provider on the provider system; and
processing the protocol calls in the communication stack on the provider system for availability over a network to clients.

2. The method as claimed in claim 1, wherein the system is the partitioned system, the application and the protocol stack interceptor-consumer running on a consumer operating system in a first partition of the partitioned system, and protocol stack interceptor-provider and the communication stack running on a provider operating system in a second partition of the partitioned system.

3. The method as claimed in claim 2 wherein the intercepted calls are transported from the first partition to the second partition using an interpartition communication mechanism in the partitioned system.

4. The method of claim 3, wherein the interpartition communication mechanism comprises at least one of virtual Ethernet driver using a remote procedure call, Infiniband, and RDMA over Ethernet.

5. The method of claim 4, wherein the application is a networked client application that couples to the communication stack having support for at least one of SCTP, DCCP and IP layers, via the protocol stack interceptor-consumer and protocol stack interceptor-provider using the interpartition communication mechanism.

6. The method as claimed in claim 5 wherein the intercepted calls are carried to designated partitions of at least one of the protocol stack interceptor-consumer, the protocol stack-provider and the communication stack.

7. The method as claimed in claim 6 wherein the protocol stack interceptor-consumer is a socket interceptor-consumer, the protocol stack-provider is a socket interceptor-provider, and the protocol stack calls are socket calls.

8. The method of claim 1, wherein the system is the networked system, the application and the protocol stack interceptor-consumer running on a consumer operating system of the networked system, and protocol stack interceptor-provider and the communication stack running on a provider operating system in a provider operating system of the networked system, the consumer and provider operating systems being in communication via a connection of hardware and at least one of a physical Ethernet, Infiniband and RDMA over Ethernet.

9. The method as claimed in claim 8 wherein the intercepted calls are transported from the consumer operating system to the provider operating system using an interpartition communication mechanism in a intersystem communication mechanism in a networked system environment.

10. The method as claimed in claim 9 wherein the intersystem communication mechanism comprises at least one of the physical Ethernet, Infiniband, and RDMA over Ethernet.

11. The method as claimed in claim 10 wherein the intercepted calls are carried to designated partitions of at least one of the protocol stack interceptor-consumer, the protocol stack-provider and the communication stack.

12. The method as claimed in claim 11 wherein the protocol stack interceptor-consumer is a socket interceptor-consumer, the protocol stack-provider is a socket interceptor-provider, and the protocol stack calls are socket calls.

13. A system for applications to utilize cross operating system features under system environments, the system comprising:
a first application;
a protocol stack interceptor-consumer coupled to the first application;
a first transport medium coupled to the protocol stack interceptor-consumer;
hardware coupled to the first transport medium;
a protocol stack interceptor-provider for receiving protocol stack calls from the first application;
a second transport medium coupled to the protocol stack interceptor-provider; and
a communication stack including a transport service layer and a transport medium driver, the communication stack coupled to the socket interceptor-provider.
wherein the communication stack processes and transfers application operations to a client application on a network via the protocol stack calls that are handed from the protocol stack interceptor-consumer to the protocol stack interceptor-provider, via transport medium support mechanisms.

14. The system as claimed in claim 13 wherein the first application, the protocol stack interceptor-consumer, the first transport medium and the hardware reside on a first partition of a partitioned system, the first partition running a first operating system, and wherein the protocol stack interceptor-provider for receiving protocol stack calls from the first application, the second transport medium and the communication stack including a SCTP layer and an Ethernet driver, reside on a second partition of the partitioned system, the second partition running a second operating system, wherein the first and second transport media are virtual Ethernets, and the protocol stack calls are socket calls.

15. The system as claimed in claim 13 wherein the first application, the protocol stack interceptor-consumer, the first transport medium and the hardware reside on a first system of a networked system, the first system running a first operating system, and wherein the protocol stack interceptor-provider for receiving protocol stack calls from the first application, the second transport medium and the communication stack including a SCTP layer and an transport medium driver, reside on a second system of the networked system, the second system running a second operating system, wherein the first and second transport media are physical Ethernets, and wherein the protocol stack calls are socket calls.

16. An article of manufacture, comprising:
a set of application program interface embodied on a computer readable medium for execution on at least one of a partitioned system and a networked system in conjunction with an application program that generate protocol stack calls, including socket calls;
a protocol stack interceptor-consumer interface that receives the protocol stack calls from the application program;
a protocol stack interceptor-provider interface that received the protocol stack calls that are handed from the protocol stack interceptor-provider interface; and
a communications stack interface having a transport service layer coupled to a transport medium driver layers, the communications stack interface receiving the protocol stack calls from the protocol stack interceptor-provider and providing the protocol stack calls to a network,
wherein the protocol stack calls are handed from the protocol stack interceptor-consumer to the protocol stack interceptor-provider via at least one of an interpartition communication mechanism in the partitioned system and an intersystem communication mechanism in the networked system.

17. The article of manufacture as claimed in claim 16, wherein the system is the partitioned system, the first application is running on a first operating system in the first partition of a first system and the second application is running on the first operating system in a second partition of the first system.

18. The article of manufacture as claimed in claim 17, wherein the interpartition communication mechanism comprises a virtual Ethernet driver.

19. The article of manufacture as claimed in claim 18, wherein the first application is a networked client application that does not have support for SCTP, the second application has support for SCTP, the first application communicates with a server application running on a remote system using SCTP by intercepting socket calls to the first application utilizing SCTP and transporting this call to the second application using the interpartition communication mechanism.

20. The article of manufacture as claimed in claim 16, wherein the system is the networked system, the intersystem communication mechanism comprises a physical Ethernet.
